(19) United States
(12) Patent Application Publication
(10) Pub. No.: US 2019/0381571 A1
(43) Pub. Date: Dec. 19, 2019

(54) METHODS AND APPARATUSES FOR PRODUCING METALLIC POWDER MATERIAL

(71) Applicant: ATI Properties LLC, Albany, OR (US)

(72) Inventors: Robin M. Forbes Jones, Saint Helena Island, SC (US); Matthew J. Arnold, Charlotte, NC (US); Ramesh S. Minisandram, Charlotte, NC (US); Arthur A. Kracke, Charlotte, NC (US)

(21) Appl. No.: 16/261,636

(22) Filed: Jan. 30, 2019

Related U.S. Application Data
(63) Continuation of application No. 14/712,103, filed on May 14, 2015, now abandoned.

(51) Int. Cl. B22F 9/08; B22F 1/00; C22C 14/00; C22C 16/00; C22C 19/03; C22C 21/00; C22C 27/02; C22C 27/04

(52) U.S. Cl. CPC B22F 9/082; B22F 1/0048; C22C 14/00; C22C 16/00; B22F 2009/0848; C22C 21/00; C22C 27/02; C22C 27/04; C22C 19/03

(57) ABSTRACT

A method of producing a metallic powder material comprises supplying feed materials to a melting hearth, and melting the feed materials on the melting hearth with a first heat source to provide a molten material having a desired chemical composition. At least a portion of the molten material is passed from the melting hearth either directly or indirectly to an atomizing hearth, where it is heated using a second heat source. At least a portion of the molten material from the atomizing hearth is passed in a molten state to an atomizing apparatus, which forms a droplet spray from the molten material. At least a portion of the droplet spray is solidified to provide a metallic powder material.

### CROSS-REFERENCE TO RELATED APPLICATIONS

The present application claims priority under 35 U.S.C. § 120 as a continuation of co-pending U.S. patent application Ser. No. 14/712,103, filed May 14, 2015, the entire disclosure of which is hereby incorporated herein by reference.

### BACKGROUND OF THE TECHNOLOGY

### Field Of Technology

The present disclosure relates to methods and apparatuses for producing a metallic powder material. In particular, certain non-limiting aspects of the present disclosure relate to methods of producing a metallic powder material using an apparatus including a melting hearth adapted to receive feed material, and an atomizing hearth disposed to receive at least a portion of molten material from the melting hearth. In certain non-limiting embodiments of the method of the present disclosure, the method includes passing at least a portion of molten material from the atomizing hearth in a molten state to an atomizing apparatus, which may include an atomizing nozzle. The present disclosure is also directed to a metallic powder material and articles produced by the methods and apparatuses of the present disclosure.

### Description of the Background of the Technology

Gas atomization and hot isostatic pressing (also referred to as “HIPing”) are conventionally used for forming a metallic article from metallic powder material. In these processes, a melt having the desired chemical composition is prepared, and the molten composition is passed through an atomizing apparatus in which gas jets disperse the molten composition into droplets that are quenched. The quenched droplets form loose powder. The metallic powder material can be hot isostatically pressed to form a metallic article.

Another conventional method for producing a metallic article is nucleated casting. Nucleated casting utilizes gas atomization to produce a spray of semi-liquid droplets that are deposited into a mold. It is commonly seen that some portion of the droplet spray, i.e., the overspray, may accumulate on a top surface of the mold. Similar in respects to nucleated casting, spray forming is a conventional technique in which a metallic article is formed from a semi-liquid droplet spray, but without using a mold.

In conventional nucleated casting, spray forming, and the gas atomizing/HIPing sequence, solidified materials that have been previously melted to the desired chemical composition are re-melted to present molten material to the atomizing apparatus. In one example, solidified material having the desired chemical composition is thermomechanically worked to a wire and is subsequently re-melted for atomization. In another example, a cold-wall induction furnace is used to melt and homogenize the previously solidified material before the atomization process. When material is solidified prior to re-melting and atomization, the material can be contaminated, such as during thermomechanical working and handling. The contaminants in the solid material can become entrained in the molten metal stream presented to the atomizing apparatus. Re-melting solidified material for atomization also can limit the ability to control process parameters such as molten metal superheat and flow rate, which may need to be controlled to ensure consistent atomization. In addition, using solidified material for re-melting and atomization can increase costs associated with the manufacture of the atomized metal powder.

### SUMMARY

The present disclosure, in part, is directed to methods and apparatuses that address certain limitations of conventional approaches for producing a metallic powder material. One non-limiting aspect of the present disclosure is directed to a method of producing a metallic powder material, the method comprising: supplying feed materials to a melting hearth; melting the feed materials in the melting hearth with a first heat source, thereby producing a molten material having a desired composition; passing at least a portion of the molten material to an atomizing hearth; heating the molten material in the atomizing hearth with a second heat source; passing at least a portion of the molten material from the atomizing hearth in a molten state directly or indirectly to an atomizing apparatus; and forming a droplet spray of the molten material with the atomizing apparatus. At least a portion of the droplet spray is solidified to provide a metallic powder material. In certain non-limiting embodiments of the method, at least a portion of the molten material passes to the atomizing apparatus continually. In certain non-limiting embodiments of the method, the molten material passes from the melting hearth to the atomizing hearth through at least one additional hearth.

Another non-limiting aspect of the present disclosure is directed to an apparatus for producing a metallic powder material. The apparatus comprises: a melting hearth adapted to receive feed materials; a first heat source adapted to melt the feed materials in the melting hearth and produce a molten material having a desired composition; an atomizing hearth disposed to directly or indirectly receive at least a portion of the molten material from the melting hearth; a second heat source adapted to heat molten material in the atomizing hearth; an atomizing apparatus adapted to form a droplet spray of the molten material; a transfer unit coupled to the atomizing hearth and the atomizing apparatus; and a collector adapted to receive the droplet spray from the atomizing apparatus. The transfer unit is adapted to pass molten material from the atomizing hearth to the atomizing apparatus in a molten state.

### BRIEF DESCRIPTION OF THE DRAWINGS

Features and advantages of the methods and alloy articles described herein may be better understood by reference to the accompanying drawings in which:

FIG. 1 is a flow chart of a non-limiting embodiment of a method of producing a metallic powder material according to the present disclosure;

FIG. 2 is a schematic cross-sectional side view illustrating a non-limiting embodiment of an apparatus for producing a metallic powder material according to the present disclosure;

FIG. 3 is a schematic plan view of the apparatus of FIG. 1;

FIG. 4 is a schematic plan view of another non-limiting embodiment of an apparatus for producing a metallic powder material according to the present disclosure;

FIG. 5 is an enlarged partial cross-sectional side view of the apparatus of FIG. 1; and

FIG. 6 is a schematic cross-sectional side view illustrating another non-limiting embodiment of an apparatus for producing a metallic powder material according to the present disclosure.

It should be understood that the invention is not limited in its application to the embodiments illustrated in the above-described drawings. The reader will appreciate the foregoing details, as well as others, upon considering the following detailed description of certain non-limiting embodiments of methods and apparatuses according to the present disclosure. The reader also may comprehend certain of such additional details upon using the methods and apparatuses described herein.

### DETAILED DESCRIPTION OF CERTAIN NON-LIMITING EMBODIMENTS

In the present description of non-limiting embodiments and in the claims, other than in the operating examples or where otherwise indicated, all numbers expressing quantities or characteristics of ingredients and products, processing conditions, and the like are to be understood as being modified in all instances by the term “about.” Accordingly, unless indicated to the contrary, any numerical parameters set forth in the following description and the attached claims are approximations that may vary depending upon the desired characteristics one seeks to obtain in the methods and apparatuses according to the present disclosure. At the very least, and not as an attempt to limit the application of the doctrine of equivalents to the scope of the claims, each numerical parameter should be construed in light of the number of reported significant digits and by applying ordinary rounding techniques.

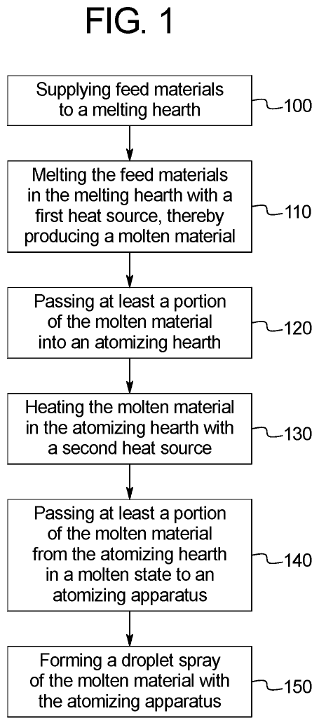

The present disclosure, in part, is directed to methods and apparatuses that address certain of the limitations of conventional approaches for producing a metallic powder material. Referring to FIG. 1, a non-limiting embodiment of a method of producing a metallic powder material is illustrated. The method includes: supplying feed materials to a melting hearth (block 100); melting the feed materials in the melting hearth with a first heat source, thereby producing a molten material (block 110) having a desired chemical composition; passing at least a portion of the molten material directly or indirectly to an atomizing hearth (block 120); heating the molten material in the atomizing hearth with a second heat source (block 130); passing at least a portion of the molten material from the atomizing hearth in a molten state to an atomizing apparatus (block 140); and forming a droplet spray of the molten material with the atomizing apparatus (block 150). At least a portion of the droplet spray is solidified to provide a metallic powder material having the desired composition.

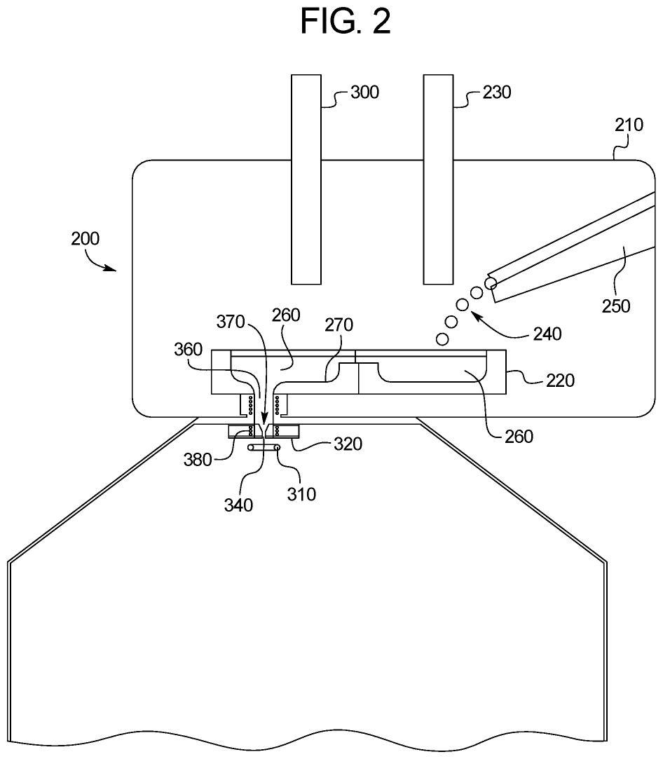

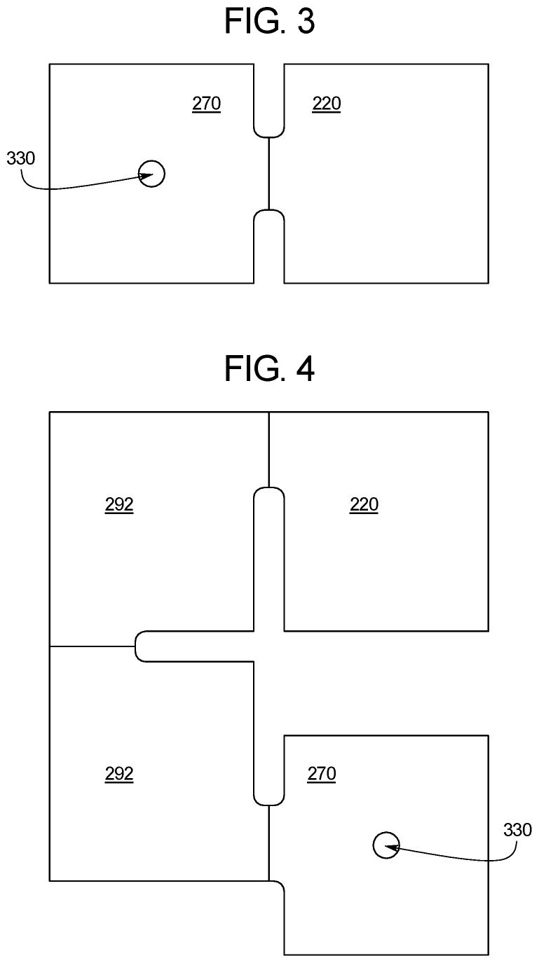

Referring to FIGS. 2-3, the illustrated non-limiting embodiment of the apparatus 200 for producing a metallic powder material comprises a melt chamber 210, and a melting hearth 220 and a first heat source 230 positioned in the melt chamber 210. The melt chamber 210 is configured to maintain an atmosphere therein. The atmosphere may have a pressure that is below atmospheric pressure, exceeds atmospheric pressure, or is at atmospheric pressure. According to certain non-limiting embodiments, the gas atmosphere in the melt chamber 210 may be chemically inert relative to the material being heated in the melt chamber 210. According to certain non-limiting embodiments, the gas atmosphere within the melt chamber 210 may be helium, argon, a blend of helium and argon, or another inert gas or gas mixture. According to other non-limiting embodiments, other gases or blends of gases are within the atmosphere in melt chamber 210, provided the gases or gas blends do not unacceptably contaminate the molten material within the melt chamber 210.

The melting hearth 220 is adapted to receive feed materials 240. According to certain non-limiting embodiments, the feed materials 240 are virgin raw materials. According to other non-limiting embodiments, the feed materials 240 include or consist of scrap materials, revert, recycled materials, and/or master alloys. According to certain non-limiting embodiments, the feed materials 240 include particulate materials. According to other non-limiting embodiments, the feed materials 240 include or consist of materials in the form of a fabricated or previously melted electrode such as, for example, previously melted materials in the shape of a cylinder or a rectangular prism. In any case, in the method according to the present disclosure, the chemical composition of the molten material produced in the melting hearth 220 is adjusted to the desired composition by the selective addition of feed materials to the melting hearth 210.

According to certain non-limiting embodiments, the feed materials 240 predominantly comprise titanium materials. According to certain non-limiting embodiments, the feed materials 240 are selected to provide a molten material having the chemical composition of one of a commercially pure titanium, a titanium alloy (e.g., Ti-6Al-4V alloy, having a composition specified in UNS R56400), and a titanium aluminide alloy (e.g., Ti-48Al-2Nb-2Cr alloy). According to another non-limiting embodiment, the feed materials 240 are selected to provide a molten material comprising, by weight, about 4 percent vanadium, about 6 percent aluminum, and balance titanium and impurities. (All percentages herein are weight percentages, unless otherwise indicated.) According to yet another non-limiting embodiment, the feed materials 240 are selected to provide a molten material having the chemical composition of one of a commercially pure nickel, a nickel alloy (e.g., Alloy 718, having a composition specified in UNS N07718), a commercially pure zirconium, a zirconium alloy (e.g., Zr 704 alloy, having a composition specified in UNS R60704), a commercially pure niobium, a niobium alloy (e.g., ATI Nb1Zr™ alloy (Type 3 and Type 4), having a composition specified in UNS R04261), a commercially pure tantalum, a tantalum alloy (e.g., Tantalum-10% tungsten alloy, having a composition specified in UNS 20255), a commercially pure tungsten, and a tungsten alloy (e.g., 90-7-3 tungsten alloy). It will be understood that the methods and apparatuses described herein are not limited to producing materials having the foregoing chemical compositions. Instead, the starting materials may be selected so as to provide a molten composition having the desired chemical composition and other desired properties. The molten materials are atomized in the methods and apparatus herein, thereby providing a metallic powder material having the chemical composition of the molten material that is atomized to the powder.

According to certain non-limiting embodiments, the feed materials 240 are fed into the melting hearth 220 via a feeding mechanism such as, for example, feed chute 250. According to certain non-limiting embodiments, the feeding mechanism includes at least one of a vibratory feeder, a chute, and a pusher. In other non-limiting embodiments, the feeding mechanism includes any other mechanisms that can suitably introduce feed materials 240 onto the melting hearth 220.

According to certain non-limiting embodiments, the first heat source 230, which is associated with the melting hearth 220, includes at least one heating device selected from a plasma torch, an electron beam generator, another heating device generating electrons, a laser, an electric arc device, and an induction coil. In one example, the first heat source 230 is adapted to melt the feed materials 240 in the melting hearth 220 using a plasma torch, to thereby produce a molten material 260 having a desired chemical composition. The first heat source 230 is adapted and positioned to heat the feed materials in the melting hearth 220 to a temperature at least as great as the melting temperature (liquidus) of the feed materials 240 and to maintain those materials in a molten state in the melting hearth 220. In certain non-limiting embodiments, the first heat source 230 heats the molten material formed in the melting hearth 220 to at least partially refine the molten material. According to certain non-limiting embodiments, the first heat source 230 may be positioned about 100 mm to about 250 mm above the upper surface of the melting hearth 220. According to other non-limiting embodiments, the first heat source 230 comprises a first plasma torch that is positioned at a height relative to the top surface of the molten material in the melting hearth 220 so that an edge of the plume of the hot plasma produced by the first plasma torch suitably heats the material. According to certain non-limiting embodiments, the power level, position relative to the melting hearth 220, and other parameters of the first heat source 230 are selected to heat the molten material 260 in the melting hearth 220 to a temperature range including the liquidus of the material up to about 500° C. above the melting point of the material. According to further embodiments, the power level, position, and other parameters of first heat source 230 are optimized to superheat the material in the melting hearth 220 to a temperature range including a temperature about 50° C. above the liquidus of the material up to about 300° C. above the liquidus of the material. According to other embodiments, the power level, position, and other parameters of the first heat source 230 are optimized to superheat the material to a temperature exceeding the liquidus of the material by any suitable degree, so long as the first heat source 230 does not vaporize the material and/or vary the chemistry of the molten material in an undesired manner.

According to certain non-limiting embodiments, an atomizing hearth 270 is disposed to receive at least a portion of the molten material 260 directly or indirectly from the melting hearth 220. Once molten and suitably heated, the molten material 260 in the melting hearth 220 may drain from the melting hearth 220 and pass directly or indirectly (e.g., through at least one additional hearth) to the atomizing hearth 270. The atomizing hearth 270 directly or indirectly collects molten material 260 from the atomizing hearth 270, and may hold at least a portion of the molten material 260 as molten material 260 passes from the atomizing hearth 270 and on to the atomizing nozzle of an atomizing apparatus 310, as further explained below. In this regard, the atomizing hearth 270 acts as a “surge buffer” for the molten material 260, regulating the flow of molten material 260 to the atomizing apparatus 310. According to certain non-limiting embodiments, the atomizing hearth 270 is disposed in the melt chamber 210 with the melting hearth 220. According to other embodiments, the atomizing hearth 270 is not in a single chamber with the melting hearth 220 and, instead, may be located in another chamber, such as an adjoining chamber.

According to various non-limiting embodiments, at least one additional hearth is disposed intermediate the melting hearth 220 and the atomizing hearth 260, and molten material passes from the melting hearth 260, through the at least one additional hearth, and into the atomizing hearth 270. This arrangement is described herein as involving passage of molten material from the melting hearth indirectly to the atomizing hearth.

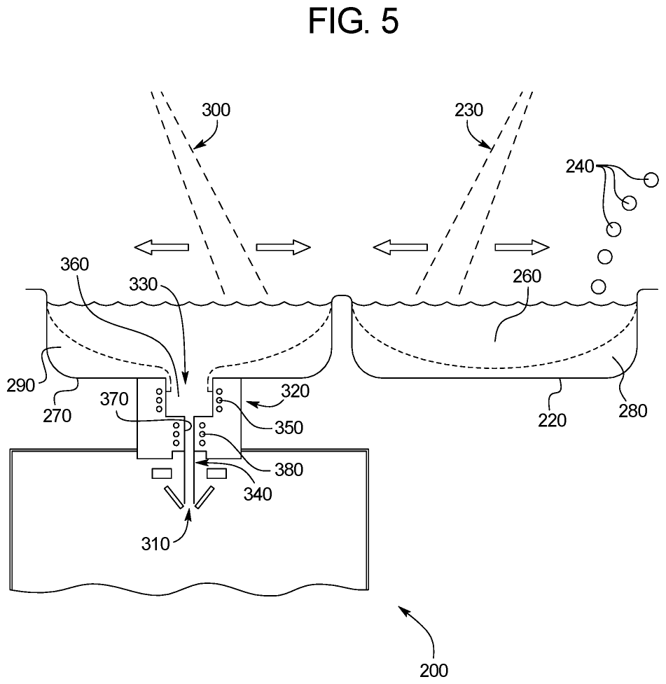

According to certain non-limiting embodiments, and with reference to FIG. 5, both the melting hearth 220 and the atomizing hearth 270 are water-cooled copper hearths. If present, the one or more additional hearths present in various non-limiting embodiments also may be water-cooled copper hearths. According to other non-limiting embodiments, at least one of the melting hearth 220, the atomizing hearth 270, and, if present, the one or more additional hearths are constructed of any other suitable materials and components and are cooled or otherwise adapted to prevent melting of the hearth as the materials are heated therein. According to certain non-limiting embodiments, a portion of the molten material 260 contacts a cooled wall of the melting hearth 220 and may solidify to form a first skull 280 that prevents the remainder of the molten material 260 from contacting the wall of the melting hearth 220, thereby insulating the wall of the melting hearth 220 from the molten material 260. Also, in certain embodiments, a portion of the molten material 260 contacts the cooled wall of the atomizing hearth 270 as the molten material 260 flows into the atomizing hearth 270 from the melting hearth 220, and may solidify on the wall to form a second skull 290 that prevents the remainder of the molten material 260 from contacting the wall of the atomizing hearth 270, thereby insulating the wall of the atomizing hearth 270 from the molten material 260. In certain non-limiting embodiments, the one or more additional hearths, if present, may operate in a similar manner to prevent undesirable contact of molten materials with the hearth walls.

Depending on the use requirements or preferences for the particular method or apparatus 200, the material on the melting hearth 220, the atomizing hearth 270, and, if present, the one or more additional hearths, may be refined and/or homogenized as it is heated. For example, in refining the molten material, high density solid inclusions and other solid contaminants in the molten material may sink to the bottom of the molten material in the particular hearth and become entrained in the skull on the hearth wall. Some low density solid inclusions or other solid contaminants may float on the surface of the molten material in the particular hearth and be vaporized by the associated heat source. Other low density solid inclusions or other solid contaminants may be neutrally buoyant and suspended slightly below the surface of the molten material, and dissolve in the molten material in the hearth. In this way, the molten material 260 is refined as solid inclusions and other solid contaminants are removed from or dissolve in the molten material 260.

Referring also to FIG. 4, according to the illustrated non-limiting embodiment, at least one additional hearth 292 is positioned between the melting hearth 220 and the atomizing hearth 270. At least a portion of the molten material 260 on the melting hearth 220 passes through the one or more additional hearth(s) 292 before passing into the atomizing hearth 270. In certain non-limiting embodiments, the additional hearth(s) 292 may be used for at least one of refining and homogenizing the molten material 260. “Refining” and “homogenizing” are terms of art and will be readily understood by those having ordinary skill in the production of metallic powder materials. In general, in connection with hearth components, refining may involve removing, dissolving, or trapping impurities or undesirable constituents from a molten material in a hearth, and preventing the impurities or undesirable constituents from progressing downstream. Homogenizing may involve mixing or blending a molten material such that the material has a more uniform composition. According to certain non-limiting embodiments, the one or more additional hearth(s) 292 are positioned in series with the melting and atomizing hearths 220, 270 to provide a flow path for the molten material 260 in a generally straight line or in an alternate shape selected from a generally zig-zag shaped path, a generally L-shaped path, and a generally C-shaped path. According to certain non-limiting embodiments, an additional heat source (not shown) is associated with one or more of the additional hearth(s) 292. According to certain non-limiting embodiments, the additional heat source includes one or more heating devices selected from a plasma torch, an electron beam generator, another heating device generating electrons, a laser, an electric arc device, and an induction coil.

According to certain non-limiting embodiments, a second heat source 300 is adapted to heat the molten material 260 in the atomizing hearth 270. According to certain non-limiting embodiments, the second heat source 300 includes at least one heat source selected from a plasma torch, an electron gun, a heating device that generates electrons, a laser, an electric arc, and an induction coil. The second heat source 300 is positioned to heat the top surface of the molten material in the atomizing hearth 270 to a temperature as least as great as the melting temperature (liquidus) of the material. According to certain non-limiting embodiments, the second heat source 300 may be positioned about 100 mm to about 250 mm above the atomizing hearth 270. According to certain non-limiting embodiments, the second heat source 300 comprises a plasma torch that is positioned at a height relative to the top surface of the molten material on the atomizing hearth 270 so that an edge of the plume of the hot plasma suitably heats the material. According to certain non-limiting embodiments, the power level, position relative to the atomizing hearth 270, and other parameters of the second heat source 300 are selected to superheat the materials on the atomizing hearth 270 to a temperature range of about 50° C. above the liquidus of the material to about 400° C. above the liquidus of the material. According to further embodiments, the power level, position, and other parameters of second heat source 300 are optimized to superheat the material on the atomizing hearth 270 to a temperature range of about 100° C. above the liquidus of the material to about 200° C. above the liquidus of the material. According to other embodiments, the power level, position, and other parameters of the second heat source 300 are optimized to superheat the material to a temperature exceeding the liquidus by any suitable degree, so long as the second heat source 300 does not vaporize the material and/or vary the chemistry of the molten material in an undesired manner.

According to certain non-limiting embodiments, an atomizing apparatus 310 includes an atomizing nozzle adapted to form a droplet spray of the molten material 260, and a transfer unit 320 is upstream of the atomizing apparatus 310. For example, the transfer unit 320 may pass molten material directly to the atomizing nozzle. The transfer unit 320 is coupled to the atomizing hearth 270 and the atomizing apparatus 310. The second heat source 300 is designed to keep molten material 260 that is flowing into the transfer unit 320 in a molten state, and the transfer unit 320 is adapted to pass at least a portion of the molten material 260 from the atomizing hearth 270 to the atomizing apparatus 310 in a molten state. Although only a combination of a single transfer unit and a single atomizing apparatus is included in the illustrated apparatus 200, it is contemplated that embodiments including multiple atomizing apparatuses, such as multiple atomizing nozzles, may be advantageous. For example, process rates may be increased and material production costs may be reduced in an apparatus employing multiple transfer units 320 and one or more atomizing nozzles or other atomizing apparatuses 310 downstream of the atomizing hearth 270.

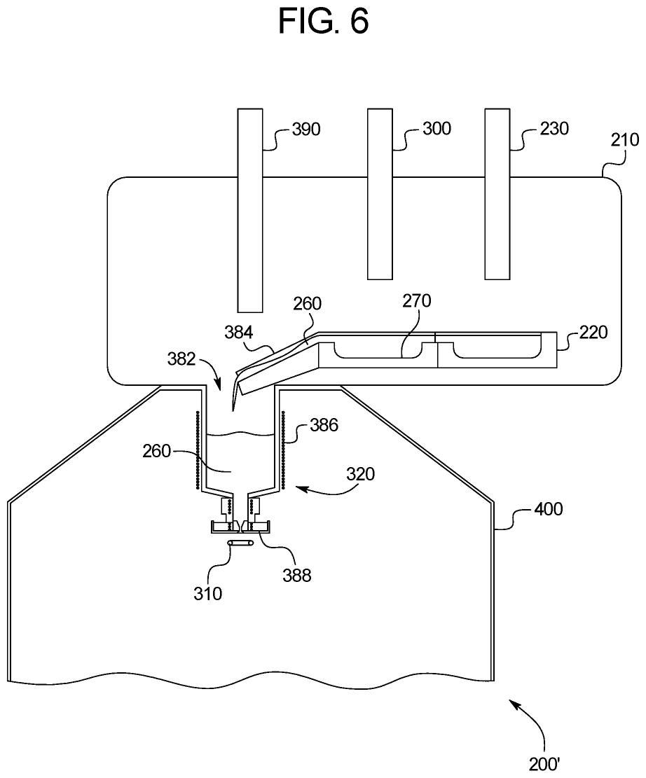

Referring to FIG. 5, according to the illustrated non-limiting embodiment, the transfer unit 320 is a cold induction guide (CIG). FIG. 6 illustrates an apparatus 200′ according to another non-limiting embodiment of the present disclosure. The transfer unit 320 of apparatus 200′ includes an induction guide 382 that optionally includes a pouring trough 384 and a segmented induction mold 386 in addition to the CIG 388. In the illustrated non-limiting embodiment of apparatus 200′, an additional heat source 390 is associated with the pouring trough 384 and segmented induction mold 386.

The transfer unit 320 maintains the purity of the molten material 260 produced in the melting hearth 220 and passing from the atomizing hearth 270 to the atomizing apparatus 310 by protecting the molten material 260 from the external atmosphere. The transfer unit also may be constructed to protect the molten material from contamination by oxides that can result from the use of a conventional atomizing nozzle. The transfer unit 320 may also be used to meter the flow of the molten material 260 from the atomizing hearth 270 to the atomizing apparatus 310, as further explained below. Those having ordinary skill, upon considering the present description, will be able to provide various possible alternate designs for transfer units and associated equipment capable of controllably transferring molten material 260, maintained in a molten state, between an atomizing hearth and an atomizing apparatus as employed in embodiments of the present apparatuses and methods. All such transfer unit designs that may be incorporated into methods and apparatuses of the present disclosure are encompassed within the present invention.

According to certain non-limiting embodiments, the transfer unit 320 includes an inlet 330 adjacent the atomizing hearth 270 and an outlet 340 adjacent the atomizing apparatus 310, and one or more electrically conductive coils 350 are positioned at the inlet 330. A source of electrical current (not shown) is in selective electrical connection with the conductive coils 350 to heat the molten material 260 and initiate the flow of at least a portion of the molten material 260 to the atomizing apparatus 310. According to certain non-limiting embodiments, the electrically conductive coils 350 are adapted to heat the molten material 260 to a temperature in the range of the liquidus of the material up to 500° C. above the liquidus.

According to certain non-limiting embodiments, the transfer unit 320 includes a melt container 360 for receiving the molten material 260, and a transfer region of the transfer unit 320 is configured to include a passage 370 constructed to receive molten material 260 from the melt container 360. The wall of the passage 370 is defined by a number of fluid-cooled metallic segments. According to certain non-limiting embodiments, the transfer unit 320 includes one or more electrically conductive coils 380 positioned at the outlet 340. The coils 380 are cooled by circulating a suitable coolant such as water or another heat-conducting fluid through conduits associated with the outlet 340. A portion of the molten material 260 contacts the cooled wall of the passage 370 of the transfer unit 320 and may solidify to form a skull that insulates the wall from contact with a remainder of the molten material 260. The cooling of the hearth wall and the formation of the skull assures that the melt is not contaminated by materials from which the inner walls of the transfer unit 320 are formed.

During the time that the molten material 260 is flowing from the melt container 360 of the transfer unit 320 through the passage 370, electrical current is passed through the conductive coils 380 at an intensity sufficient to inductively heat the molten material 260 and maintain it in molten form. The coils 380 serve as induction heating coils and adjustably heat the molten material 260 passing through the outlet 340 of the transfer unit 320. According to certain non-limiting embodiments, the electrically conductive coils 380 are adapted to heat the molten material 260 to a temperature in the range of 50° C. above the liquidus of the material up to 400° C. above the liquidus. In further embodiments, the electrically conductive coils 380 are adapted to heat the molten material 260 to a temperature in the range of the liquidus temperature of the material up to 500° C. above the liquidus. According to certain other non-limiting embodiments, the electrically conductive coils 380 are adapted to selectively prevent passage of the molten material 260 to the atomizing apparatus 310.

According to certain non-limiting embodiments, at least a portion of the molten material 260 passes to the atomizing apparatus 310 continually. In such non-limiting embodiments, molten material 260 flows continually from the melting hearth 220 to the atomizing hearth 270, through the transfer unit 320, exits outlet 340 of the transfer unit 320, and passes into the atomizing apparatus 310. In certain non-limiting embodiments, the flow of molten material 260 to the atomizing hearth 270 may be discontinuous, i.e., with starts and stops. In various non-limiting embodiments, molten material 260 flows from the melting hearth 220, through at least one additional hearth, and to the atomizing hearth 270, through the transfer unit 320, exits outlet 340 of the transfer unit 320, and passes into the atomizing apparatus 310. According to certain non-limiting embodiments, the atomizing apparatus 310 comprises an atomizing nozzle including a plurality of plasma atomizing torches that converge at a point and form a droplet spray of the molten material 260. According to further non-limiting embodiments, the atomizing nozzle includes three plasma torches that are equally distributed to define angles of about 120° between one another. In such embodiments, each of the plasma torches also may be positioned to form an angle of 30° with respect to the axis of the atomizing nozzle. According to certain non-limiting embodiments, the atomizing apparatus 310 includes an atomizing nozzle that includes plasma jets generated by D.C. guns operating in the power range of 20 to 40 kW. According to certain non-limiting embodiments, the atomizing apparatus 310 comprises an atomizing nozzle that forms at least one gas jet that disperses the molten material 260 to form the droplet spray.

The resulting droplet spray is directed into a collector 400. According to certain non-limiting embodiments, a position of the collector 400 relative to the atomizing nozzle or other atomizing apparatus 310 is adjustable. The distance between the point of atomization and the collector 400 may control the solids fraction in the material deposited in the collector 400. Thus, as the material is deposited, the position of the collector 400 relative to the atomizing nozzle or other atomizing apparatus 310 may be adjusted so that the distance between the surface of the collected material in the collector 400 and the atomizing nozzle or other atomizing apparatus 310 is suitably maintained. According to certain non-limiting embodiments, the collector 400 is selected from a chamber, a mold, and a rotating mandrel. For example, in certain non-limiting embodiments, as the material is deposited into the collector 400, the collector 400 may rotate to better ensure uniform deposition of the droplets over a surface of the collector 400.

Although the foregoing description of the apparatus 200 refers to the melting hearth 220, the atomizing hearth 270, the atomizing apparatus 310, the transfer unit 320, and the collector 400 as relatively discrete units or components of the apparatus associated in series, it will be understood that the apparatus 200 need not be constructed in that way. Rather than being constructed of discrete, disconnectable melting (and/or melting/refining), transfer, atomizing, and collector units, an apparatus according to the present disclosure, such as apparatus 200, may incorporate elements or regions providing the essential features of each of those units, but without being capable of deconstruction into discrete and individually operable apparatuses or units. Thus, reference in the appended claims to a melting hearth, an atomizing hearth, an atomizing apparatus, a transfer unit, and a collector should not be construed to mean that such distinct units may be disassociated from the claimed apparatus without loss of operability.

In certain non-limiting embodiments, a metallic powder material produced according to various non-limiting embodiments of the methods, or by the various non-limiting embodiments of apparatuses, disclosed herein comprises an average particle size of 10 to 150 microns. In certain non-limiting embodiments, a metallic powder material produced according to various non-limiting embodiments of the methods, or by the various non-limiting embodiments of apparatuses, disclosed herein has a particle size distribution of 40 to 120 microns (i.e., the particle size of substantially all the powder particles falls in the range of 40 to 120 microns). A metallic powder material having a particle size distribution of 40 to 120 microns is particularly useful in electron beam additive manufacturing applications. In certain non-limiting embodiments, a metallic powder material produced according to various non-limiting embodiments of the methods, or by the various non-limiting embodiments of apparatuses, disclosed herein has a particle size distribution of 15 to 45 microns (i.e., the particle size of substantially all the powder particles falls in the range of 15 to 45 microns). A metallic powder material having a particle size distribution of 15 to 45 microns is particularly useful in laser additive manufacturing applications. According to certain non-limiting embodiments, the metallic powder material comprises spherical particles. In certain other non-limiting embodiments, at least a portion of the metallic powder material has other geometric forms, including, but not limited to, flakes, chips, needles, and combinations thereof.

According to certain non-limiting embodiments, the metallic powder material has a composition that cannot be readily produced by conventional ingot metallurgy, e.g., melting and casting technologies. That is, the methods that have been described herein may be able to produce a metallic powder material with a composition that would either be too segregation-prone or have properties that prevent it from being cast by conventional ingot metallurgy. According to certain non-limiting embodiments, a boron content of the metallic powder material is greater than 10 ppm, based on total powder material weight. In conventional ingot melting and casting, boron levels above 10 ppm can produce detrimental borides. In contrast, various non-limiting embodiments of the methods described herein permit a metallic powder material having a boron content greater than 10 ppm to be produced without exhibiting unacceptable detrimental phases or properties. This expands the possibilities for compositions of metallic powder material that can be produced.

Metallic powder materials made according the methods and apparatuses of the present disclosure may have any composition suitably made using the present methods and apparatuses. According to certain non-limiting embodiments, the metallic powder materials have the chemical composition of one of a commercially pure titanium, a titanium alloy (e.g., Ti-6Al-4V alloy, having a composition specified in UNS R56400), and a titanium aluminide alloy (e.g., Ti-48Al-2Nb-2Cr alloy). According to another non-limiting embodiment, the metallic powder materials have a chemical composition material comprising, by weight, about 4 percent vanadium, about 6 percent aluminum, and balance titanium and impurities. (All percentages herein are weight percentages, unless otherwise indicated.) According to yet another non-limiting embodiment, the metallic powder materials have the chemical composition of one of a commercially pure nickel, a nickel alloy (e.g., Alloy 718, having a composition specified in UNS N07718), a commercially pure zirconium, a zirconium alloy (e.g., Zr 704 alloy, having a composition specified in UNS R60704), a commercially pure niobium, a niobium alloy (e.g., ATI Nb1Zr™ alloy (Type 3 and Type 4), having a composition specified in UNS R04261), a commercially pure tantalum, a tantalum alloy (e.g., Tantalum-10% tungsten alloy, having a composition specified in UNS 20255), a commercially pure tungsten, and a tungsten alloy (e.g., 90-7-3 tungsten alloy). It will be understood that the methods and apparatuses described herein are not limited to producing metallic powder materials having the foregoing chemical compositions. Instead, the starting materials may be selected so as to provide a metallic powder material having the desired chemical composition and other desired properties.

Metallic powder materials made according the present methods and/or using the present apparatuses may be made into metallic (e.g., metal and metal alloy) articles by hot isostatic pressing techniques and other suitable conventional techniques for forming articles from metallurgical powders. Such other suitable techniques will be readily apparent to those having ordinary skill upon considering the present disclosure.

Although the foregoing description has necessarily presented only a limited number of embodiments, those of ordinary skill in the relevant art will appreciate that various changes in the methods and apparatuses and other details of the examples that have been described and illustrated herein may be made by those skilled in the art, and all such modifications will remain within the principle and scope of the present disclosure as expressed herein and in the appended claims. It is understood, therefore, that the present invention is not limited to the particular embodiments disclosed or incorporated herein, but is intended to cover modifications that are within the principle and scope of the invention, as defined by the claims. It will also be appreciated by those skilled in the art that changes could be made to the embodiments above without departing from the broad inventive concept thereof.

1.-44. (canceled)

45. A method for producing a titanium alloy powder, the method comprising:
supplying feed materials to a water-cooled copper melting hearth;
melting the feed materials in the water-cooled copper melting hearth with a first plasma torch, thereby producing a molten titanium alloy material in the water-cooled copper melting hearth;
passing at least a portion of the molten titanium alloy material from the water-cooled copper melting hearth to a water-cooled copper atomizing hearth;
heating the molten titanium alloy material in the water-cooled copper atomizing hearth with a second plasma torch;
passing at least a portion of the molten titanium alloy material directly from the water-cooled copper atomizing hearth through a cold induction guide to a gas-atomizing nozzle, wherein the cold induction guide is directly coupled to, and disconnectable from, the water-cooled copper atomizing hearth, and wherein the cold induction guide comprises:
a passage in direct fluid communication with the water-cooled copper atomizing hearth and the gas-atomizing nozzle, the passage comprising a water-cooled wall containing molten titanium alloy material received from the water-cooled copper atomizing hearth; and
an induction coil that selectively heats at least a portion of the molten titanium alloy material contained in the passage and controls solidification and flow of the molten titanium alloy material in the passage;
impinging a gas jet onto a stream of the molten titanium alloy material in the gas-atomizing nozzle, thereby dispersing the stream of molten titanium alloy material into molten titanium alloy droplets;
solidifying the molten titanium alloy droplets, thereby forming a titanium alloy powder; and
collecting the titanium alloy powder.

46. The method of claim 45, wherein the induction coil is configured to heat the molten titanium alloy material to maintain a temperature in a range of a liquidus temperature of the titanium alloy to a temperature 500° C. above the liquidus temperature.

47. The method of claim 45, wherein the cold induction guide comprises:
an inlet to the passage in direct fluid communication with the water-cooled copper atomizing hearth;
an outlet from the passage in direct fluid communication with the gas-atomizing nozzle;
a first induction coil located along the passage toward the inlet, wherein the first induction coil is configured to heat and melt solid titanium alloy material located in the passage and initiate flow of the molten titanium alloy material through the passage; and
a second induction coil located along the passage toward the outlet, wherein the second induction coil is configured to adjustably heat the molten titanium alloy material flowing through the passage from the water-cooled copper atomizing hearth to the gas-atomizing nozzle.

48. The method of claim 47, wherein the first induction coil and the second induction coil are configured to independently heat the molten titanium alloy material to maintain a temperature in a range of a liquidus temperature of the titanium alloy to a temperature 500° C. above the liquidus temperature.

49. The method of claim 45, wherein at least a portion of the molten titanium alloy material passes from the water-cooled copper melting hearth through at least one additional water-cooled copper hearth before entering the water-cooled copper atomizing hearth.

50. The method of claim 45, wherein a composition of the titanium alloy powder comprises, by weight, about 4 percent vanadium, about 6 percent aluminum, and balance titanium and impurities.

51. The method of claim 45, wherein the titanium alloy powder comprises a Ti-6Al-4V alloy having a composition specified in UNS R56400.

52. The method of claim 45, wherein the titanium alloy powder comprises a titanium aluminide composition.

53. The method of claim 45, wherein a composition of the titanium alloy powder comprises, by weight, about 48 percent aluminum, 2 percent niobium, 2 percent chromium, and balance titanium and impurities.

54. The method of claim 45, wherein a composition of the titanium alloy powder comprises greater than 10 ppm boron.

55. A method for producing an alloy powder, the method comprising:
supplying feed materials to a water-cooled copper melting hearth;
melting the feed materials in the water-cooled copper melting hearth with a first plasma torch, thereby producing a molten alloy material in the water-cooled copper melting hearth;
passing at least a portion of the molten alloy material from the water-cooled copper melting hearth to a water-cooled copper atomizing hearth;
heating the molten alloy material in the water-cooled copper atomizing hearth with a second plasma torch;
passing at least a portion of the molten alloy material directly from the water-cooled copper atomizing hearth through a cold induction guide to a gas-atomizing nozzle, wherein the cold induction guide is directly coupled to, and disconnectable from, the water-cooled copper atomizing hearth, and wherein the cold induction guide comprises:
a passage in direct fluid communication with the water-cooled copper atomizing hearth and the gas-atomizing nozzle, the passage comprising a water-cooled wall containing molten alloy material received from the water-cooled copper atomizing hearth; and
an induction coil that selectively heats at least a portion of the molten alloy material contained in the passage and controls solidification and flow of the molten alloy material in the passage;
impinging a gas jet onto a stream of the molten alloy material in the gas-atomizing nozzle, thereby dispersing the stream of molten alloy material into molten alloy droplets;
solidifying the molten alloy droplets, thereby forming an alloy powder; and
collecting the alloy powder.

56. The method of claim 55, wherein the cold induction guide comprises:
an inlet to the passage in direct fluid communication with the water-cooled copper atomizing hearth;
an outlet from the passage in direct fluid communication with the gas-atomizing nozzle;
a first induction coil located along the passage toward the inlet, wherein the first induction coil is configured to heat and melt solid alloy material located in the passage and initiate flow of the molten alloy material through the passage; and
a second induction coil located along the passage toward the outlet, wherein the second induction coil is configured to adjustably heat the molten alloy material flowing through the passage from the water-cooled copper atomizing hearth to the gas-atomizing nozzle;
wherein the first induction coil and the second induction coil are configured to independently heat the molten alloy material.

57. The method of claim 55, wherein the alloy powder comprises a titanium alloy, a titanium aluminide alloy, a zirconium alloy, a niobium alloy, a tantalum alloy, or a tungsten alloy.

58. A method for producing a metallic powder, the method comprising:
supplying feed materials to a water-cooled copper melting hearth;
melting the feed materials in the water-cooled copper melting hearth with a first plasma torch or a first electron beam gun, thereby producing a molten metallic material in the water-cooled copper melting hearth;
passing at least a portion of the molten metallic material from the water-cooled copper melting hearth to a water-cooled copper atomizing hearth;
heating the molten metallic material in the water-cooled copper atomizing hearth with a second plasma torch or a second electron beam gun;
passing at least a portion of the molten metallic material directly from the water-cooled copper atomizing hearth through a cold induction guide to an atomizing nozzle, wherein the cold induction guide is directly coupled to, and disconnectable from, the water-cooled copper atomizing hearth, and wherein the cold induction guide comprises:
a passage in direct fluid communication with the water-cooled copper atomizing hearth and the atomizing nozzle, the passage comprising a water-cooled wall containing molten metallic material received from the water-cooled copper atomizing hearth; and
an induction coil that selectively heats at least a portion of the molten metallic material contained in the passage and controls solidification and flow of the molten metallic material in the passage;
forming a spray of molten metallic material droplets in the atomizing nozzle;
solidifying the molten metallic droplets, thereby forming a metallic powder; and
collecting the metallic powder.

59. The method of claim 58, wherein the atomizing nozzle comprises a plurality of plasma atomizing torches forming plasma jets that converge at a point and form the droplet spray from the molten metallic material.

60. The method of claim 58, wherein the atomizing nozzle forms at least one gas jet that disperses the molten metallic material into the droplet spray.

61. The method of claim 58, wherein a composition of the metallic powder comprises commercially pure titanium, a titanium alloy, a titanium aluminide alloy, commercially pure zirconium, a zirconium alloy, commercially pure niobium, a niobium alloy, commercially pure tantalum, a tantalum alloy, commercially pure tungsten, a tungsten alloy, commercially pure nickel, or a nickel alloy.

62. The method of claim 58, wherein an average particle size the metallic powder is in a range of 10 microns to 150 microns.

63. The method of claim 58, wherein a particle size distribution of the metallic powder is 40 microns to 120 microns.

64. The method of claim 58, wherein a particle size distribution of the metallic powder is 15 microns to 45 microns.
